(19) United States
(12) Patent Application Publication
(10) Pub. No.: US 2012/0107184 A1
(43) Pub. Date: May 3, 2012

(54) DECONTAMINATION APPARATUS

(75) Inventors: Bolanle A. Asiyanbola, Baltimore, MD (US); Ralph Etienne-Cummings, Baltimore, MD (US); A. Roger Hammons, JR., Laurel, MD (US); Akinwale A. Akinpelu, Laurel, MD (US); Ronald L. Stanford, Laurel, MD (US)

(73) Assignee: The Johns Hopkins University, Baltimore, MD (US)

(21) Appl. No.: 13/284,563

(22) Filed: Oct. 28, 2011

Related U.S. Application Data
(63) Continuation-in-part of application No. PCT/US2010/033250, filed on Apr. 30, 2010.
(60) Provisional application No. 61/174,261, filed on Apr. 30, 2009.
(60) Provisional application No. 61/293,031, filed on Jan. 7, 2010.

(51) Int. Cl. B01J 19/00; B01J 19/12; B01J 19/28

(52) U.S. Cl. 422/119; 422/292; 422/300; 422/291

(57) ABSTRACT

A decontamination apparatus is provided including an enclosure. A first and second decontamination system may be provided within the enclosure. The first and second decontamination systems may be arranged within the enclosure and configured to decontaminate the articles received in the enclosure. The first and second decontamination systems may rely on different methods of decontamination. The enclosure of the decontamination apparatus may be defined by a plurality of connected prefabricated modular walls. A mobile control and supply module may also be provided.

### CROSS REFERENCE TO RELATED APPLICATIONS

This application is a continuation-in-part of International Application No. PCT/US2010/033250, filed Apr. 30, 2010, which claims the priority benefit of U.S. Provisional Application No. 61/174,261, filed Apr. 30, 2009, and U.S. Provisional Application No. 61/293,031, filed Jan. 7, 2010. The entire contents of each of the foregoing applications are hereby incorporated by reference.

### STATEMENT REGARDING FEDERALLY SPONSORED RESEARCH OR DEVELOPMENT

This invention was made, in part, with U.S. Government support under research Grant No. EEC9731478, awarded by the National Science Foundation Engineering Research Center on Computer Integrated Surgical Systems and Technology. The U.S. Government has certain rights in this invention.

### BACKGROUND

1. Field of Invention

This invention relates generally to decontamination, and, more particularly, to a decontamination apparatus comprising more than one decontamination system or a system for maneuvering items within the decontamination apparatus, or both. The decontamination apparatus may be a modular assembly and may include a mobile control and supply module.

2. Related Art

For more than a century, the medical community has understood the need to disinfect objects to limit the spread of disease from person to person. Indeed, the autoclave, commonly thought of as the most basic means of disinfection of objects, was invented by Charles Chamberland in 1879 and its precursor, the steam digester, was developed by Denis Papin in 1679. In the medical environment there is a need to decontaminate surfaces of all objects. Similar needs for decontamination are found in other environments as well, food service being one example. Though many decades have passed, engineers still strive to find effective means of disinfecting and decontaminating for varied objects and locations.

Healthcare associated infections account for almost 100,000 deaths annually, and billions of dollars in health care costs and cause immeasurable morbidity to patients suffering from these infections. Interventions that can demonstrably reduce these infections help to reduce this public health burden. The contribution of contaminated non-critical medical equipment to healthcare associated infections has not been precisely quantified. However, the long-standing strategy of manual decontamination is insufficient for preventing avoidable infection.

Billions of dollars are spent annually on disposable parts of non-critical medical equipment on the theory that disposal of these items will decrease the spread of bacteria and disease. Similarly, other industries use disposable items for presumed cleanliness and convenience. However, there appears to be no correlation between the use of disposables and disease transmission rates, and the disposal of the waste items poses considerable environmental strain.

In addition, significant time and expense may be required to decontaminate some items by hand, as by swabbing with a biocide. Workers do not to achieve 100% decontamination much of the time. And, after the hand decontamination is “completed,” the items are again exposed to contaminants in the immediate environment. Moreover, it is well understood that such hand decontamination is not thorough and cannot reach all surfaces of the items.

Further, the items in an environment in need of decontamination can come in all different types, shapes, sizes and weights. These parameters can prohibit the use of some forms of decontamination for some items. For example, in a medical environment, an IV pump is supported on a wheeled pole that is above the height of an average human. Similarly, a wheelchair is large and bulky. Such items cannot be placed in a table-top box, such as an autoclave, for decontamination, and both possess many nooks and crannies that would be virtually impossible to decontaminate by hand. As another example, an ECG machine contains complex electrical components and cannot be exposed to liquid or steam decontaminants, as in an autoclave. Traditional methods of decontamination may require that these items be moved to another location within a medical facility at great aggregate expense.

Some current decontamination systems use only one modality which can lead to resistant organisms. The specific mode of decontamination may be insufficient to thoroughly decontaminate all items. For example, ultraviolet light cannot access and decontaminate areas underneath surface dirt or debris. And, those systems that require human manipulation of items to be decontaminated, introduce new contaminants from those very humans.

Finally, some methods of decontamination in situ require the evacuation of the space of all humans, as in fumigating a room. And, some methods result in hazardous substances being left in the space or on surfaces.

Thus, there is a need for an improved means of decontamination that combines multiple methods of decontamination, allows manipulation of items during decontamination and may be portable and accommodate different sizes and types of equipment.

### SUMMARY

One aspect of the present disclosure is directed to a decontamination apparatus. The decontamination apparatus may include an enclosure and two decontamination systems that utilize different mechanisms to effect decontamination. A decontamination system may utilize a chemical decontamination mechanism. The decontamination apparatus may also be adapted to deliver a chemical decontaminant by a spray or fog or any other method. A decontamination system may utilize a UV light decontamination mechanism. The decontamination apparatus may include a robotic arm and may be adapted to be movable from one location to another. The decontamination apparatus may also include a system for observing the inside of the enclosure from outside of the enclosure. The decontamination apparatus may include a system for moving items within the enclosure which may be adapted to rotate the items. The decontamination apparatus may be adapted to contain deployable and stowable surfaces. Also, the decontamination apparatus may include a system for moving any gases, such as air or a chemical decontaminant, within the enclosure. This gas-moving system may include a fan blade. The decontamination apparatus may include a system for automating the decontamination process and may allow for recording and storing data. The decontamination apparatus may include a mechanized system for labeling the articles before, during or after decontamination and may include a chemically reactive label or a time sensitive label. The decontamination apparatus may include a system for evacuating or exchanging the atmosphere within the enclosure.

According to another embodiment, a modular decontamination apparatus is provided. The modular decontamination apparatus may include an enclosure adapted to contain articles to be decontaminated. The enclosure may be defined by a plurality of connected prefabricated modular walls. A first decontamination system may be arranged within the enclosure and configured to decontaminate the articles received in the enclosure. A mobile control and supply module may also be provided.

Further aspects of the nature and advantages of the invention will become apparent from the summary above and the following detailed description when taken in conjunction with the drawings.

### BRIEF DESCRIPTION OF THE DRAWINGS

The accompanying drawings, which are incorporated in and constitute a part of this specification, illustrate an implementation of the invention and, together with the description, explain the goals, advantages and principles of the invention. Corresponding reference numerals indicate corresponding parts throughout the several views of the drawings. In the drawings:

FIG. 1 is a perspective view of a decontamination apparatus according to an exemplary disclosed embodiment;

FIG. 2 is a perspective view of a decontamination apparatus according to an exemplary disclosed embodiment;

FIG. 3 is a perspective view of a decontamination apparatus according to an exemplary disclosed embodiment;

FIG. 4 is a perspective view of a decontamination apparatus according to an exemplary disclosed embodiment;

FIG. 5 is a perspective view of a decontamination apparatus according to an exemplary disclosed embodiment;

FIG. 6 is a perspective view of a decontamination apparatus according to an exemplary disclosed embodiment;

FIG. 7 is a perspective view of a decontamination apparatus according to an exemplary disclosed embodiment;

FIG. 8 is a block diagram of a decontamination apparatus according to an exemplary disclosed embodiment;

FIG. 9 is a front perspective view of a modular decontamination apparatus according to another exemplary disclosed embodiment;

FIG. 10 is a rear perspective view of the modular decontamination apparatus according to the embodiment shown in FIG. 9;

FIG. 11 is a detailed perspective view of a top of the modular decontamination apparatus according to the embodiment shown in FIG. 9;

FIG. 12 is a partial perspective view of an interior bottom portion of the modular decontamination apparatus according to the embodiment shown in FIG. 9;

FIG. 13 is a perspective view of a prefabricated modular side wall or panel for constructing a modular decontamination apparatus such as in the embodiment shown in FIG. 9;

FIG. 14 is a perspective view of another prefabricated modular side wall or panel for constructing a modular decontamination apparatus according to another embodiment;

FIG. 15 is a perspective view of another prefabricated modular side wall or panel for constructing a modular decontamination apparatus according to another embodiment;

FIG. 16 is a perspective view of a prefabricated modular ceiling wall or panel for constructing a modular decontamination apparatus according to another embodiment;

FIG. 17 is a perspective view of another prefabricated modular bottom wall or panel for constructing a modular decontamination apparatus according to another embodiment;

FIG. 18 is a front perspective view of a two unit modular decontamination apparatus according to another exemplary disclosed embodiment;

FIG. 19 is a front perspective view of a three unit modular decontamination apparatus according to another exemplary disclosed embodiment;

FIGS. 20-21 are front perspective views of a six unit modular decontamination apparatus according to another exemplary disclosed embodiment;

FIG. 22 is a rear perspective view of a six unit modular decontamination apparatus according to another embodiment;

FIG. 23 is a side view of the six unit modular decontamination apparatus according to the embodiment shown in FIG. 22;

FIG. 24 is a partial perspective view of an interior bottom portion of the modular decontamination apparatus according to the embodiment shown in FIGS. 20-23;

FIG. 25 is a front perspective view of an equipment hanger rack for use with a modular decontamination apparatus according to another exemplary disclosed embodiment;

FIG. 26 is a front perspective view of the equipment hanger rack of FIG. 25 positioned within a modular decontamination apparatus according to another exemplary disclosed embodiment;

FIG. 27 is a front detailed perspective view of the equipment hanger rack positioned within the modular decontamination apparatus as shown in FIG. 26;

FIG. 28 is a front perspective view of a removable turntable cover for use in a modular decontamination apparatus according to another exemplary disclosed embodiment;

FIG. 29 is a front perspective view of a portable control module for use with a modular decontamination apparatus according to another exemplary disclosed embodiment;

FIG. 30 is a front view of the portable control module according to the embodiment depicted in FIG. 29; and

FIG. 31 is a front perspective view of a modular decontamination system including a modular decontamination apparatus and a portable control module according to another exemplary disclosed embodiment.

### DETAILED DESCRIPTION

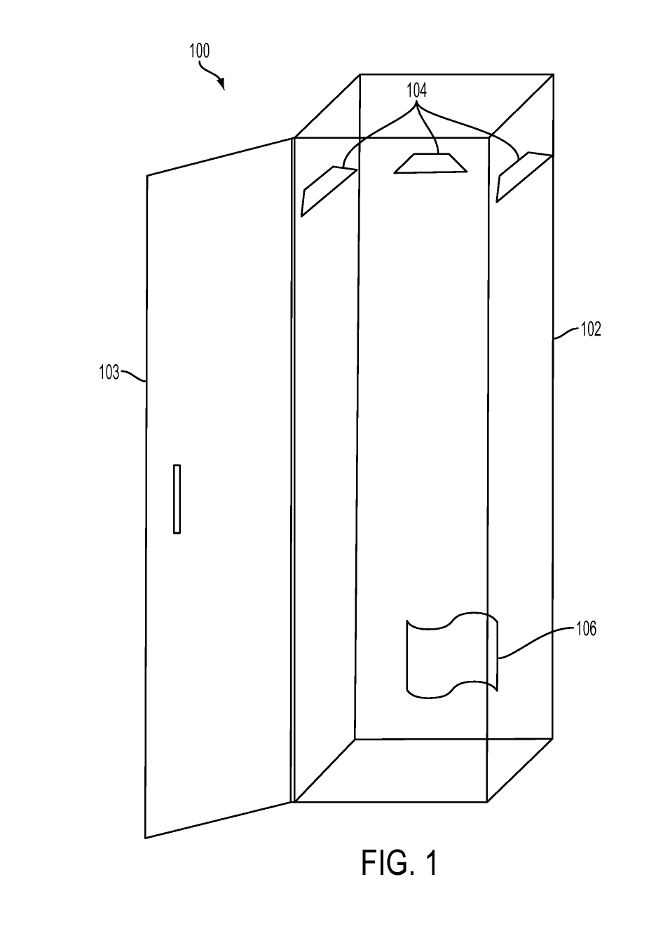

An exemplary embodiment of a decontamination apparatus, constructed according to the principles of the present disclosure, is indicated generally as 100 in FIG. 1. The decontamination apparatus 100 generally comprises an enclosure 102, a first decontamination system 104 and a second decontamination system 106.

The enclosure 102 may be rectangular, polygonal, spherical, cylindrical or any other shape suitable for containing articles to be decontaminated. The enclosure 102 may be composed of plastic, steel, polyvinyl chloride, rubber, wood, or any other single material or combination of materials suitable for use with the chosen decontamination systems. The enclosure 102 may be adapted to open or close by use of a hinged door 103, removable lid, rotatable plate, sliding plate or any other device known in the art. The enclosure 102 may be adapted to seal sufficiently to contain the chosen decontamination systems' byproducts which may include liquids, solids, gases, light, heat or any other byproducts known in the art. The enclosure 102 may be adapted to seal via a gasket, water, weights, rubber, cork, fabric, gum, paste, oil or any other seal known in the art. The enclosure 102 may be of any size appropriate to contain articles to be decontaminated. The enclosure 102 may be small enough to be carried by a single person. The enclosure 102 may be large enough for one or more humans to enter. The enclosure 102 may be large enough for a cart, bed, dolly, or other transporting device to enter. The enclosure 102 may be of sufficient size to contain multiple pieces and types of equipment for decontamination.

The first decontamination system 104 may be an a chemical system, a biocidal system, a light-based system, a radiation-based system, an ultraviolet system, a heat-based system, a liquid-dispersing system or any other system for decontamination known in the art. The first decontamination system 104 may be affixed to the interior of the enclosure 102. The first decontamination system 104 may be unattached to the interior of the enclosure 102. The first decontamination system 104 may be removably affixed to the interior of the enclosure 102. The first decontamination system 104 may be slidably affixed to the interior of the enclosure 102. The first decontamination system 104 may be connected to the interior of the enclosure 102 by a hose, a wire, or any other means known in the art suitable for facilitating the function of the system. The first decontamination system 104 may be affixed to the floor portion, the ceiling portion, the wall portion, the lower portion, the middle portion, the upper portion or any other portion of the interior of the enclosure 102. The first decontamination system 104 may be adapted to an appropriate size to fit within the enclosure 102. The first decontamination system 104 may be adapted to deliver the particular type of decontamination chosen. The first decontamination system 104 may be adapted to deliver a chemical by distributing a fog of the chemical throughout the enclosure. The first decontamination system 104 may be a chemical selected from the group comprising water, Sporicidin®, Oxivir Tb, SafeSpace®, B Sanitized or any other chemical for decontamination known in the art.

The second decontamination system 106 may be a chemical system, a biocidal system, a light-based system, a radiation-based system, an ultraviolet system, a heat-based system, a liquid-dispersing system or any other system for decontamination known in the art that relies on a different type of decontamination than the first decontamination system 104. The second decontamination system 106 may be affixed to the interior of the enclosure 102. The second decontamination system 106 may be unattached to the interior of the enclosure 102. The second decontamination system 106 may be removably affixed to the interior of the enclosure 102. The second decontamination system 106 may be slidably affixed to the interior of the enclosure 102. The second decontamination system 104 may be connected to the interior of the enclosure 102 by a hose, a wire, or any other means known in the art suitable for facilitating the function of the system. The second decontamination system 106 may be affixed to the floor portion, the ceiling portion, the wall portion, the lower portion, the middle portion, the upper portion or any other portion of the interior of the enclosure 102. The second decontamination system 104 may be adapted to an appropriate size to fit within the enclosure 102. The second decontamination system 104 may be adapted to deliver the particular type of decontamination chosen. The second decontamination system 104 may be adapted to deliver a chemical by distributing a fog of the chemical throughout the enclosure. The second decontamination system 104 may be a chemical selected from the group comprising water, Sporicidin®, Oxivir Tb, SafeSpace®, B Sanitized or any other chemical for decontamination known in the art.

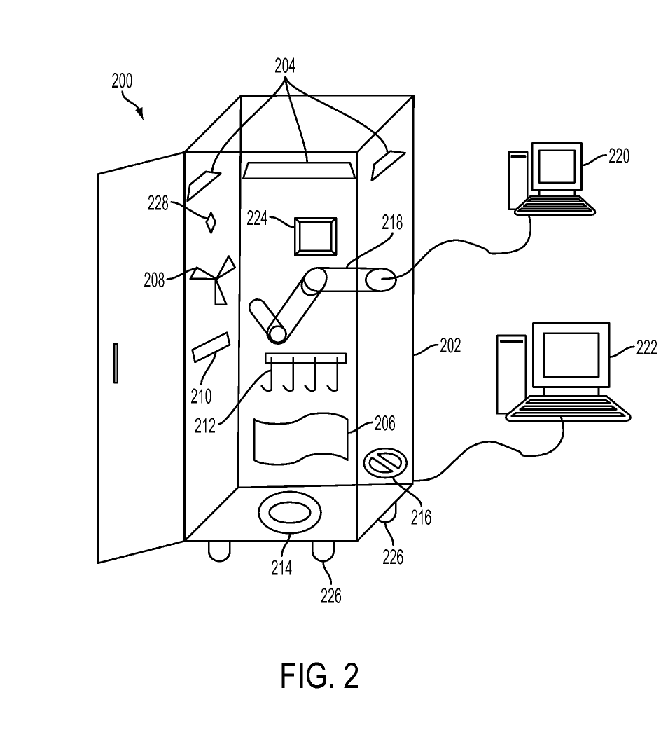

Another exemplary embodiment of a decontamination apparatus, constructed according to the principles of the present disclosure, is indicated generally as 200 in FIG. 2. The decontamination apparatus 200 may include a first decontamination system 204 and a second decontamination system 206. A fogger 228 may be provided which is adapted to deliver a chemical by distributing a fog of the chemical throughout the enclosure. The fogger 228 may deliver the chemical in the form of a gas, liquid, suspension, solution, aerosol, or any other form known in the art. The fogger 228 may be affixed to the interior of the enclosure 202. The fogger 228 may be unattached to the interior of the enclosure 202. The fogger 228 may be removably affixed to the interior of the enclosure 202. The fogger 228 may be slidably affixed to the interior of the enclosure 202. The fogger 228 may be connected to the interior of the enclosure 102 by a hose, a wire, or any other means known in the art suitable for facilitating the function of the fogger 228. The fogger 228 may be adapted to move throughout the interior of the enclosure 202 along any spatial axis.

The decontamination apparatus 200 may include a robotic arm 218 adapted to direct a decontamination system at a target surface. The robotic arm 218 may be adapted to move items within the enclosure 202 and such items may include articles to be decontaminated, fixtures within the enclosure or any other items to be moved. The robotic arm 218 may be adapted to move items throughout the interior of the enclosure 202 along any spatial axis. The robotic arm 218 may be adapted to rotate items along any rotational axis of the item. The robotic arm 218 may be adapted to move the fogger 228 within the enclosure. The robotic arm 218 may be adapted to move the fogger 228 throughout the interior of the enclosure 202 along any spatial axis. The robotic arm 218 may be adapted to rotate the fogger 228 along any rotational axis of the fogger 228. The robotic arm 218 may be adapted to direct the fogger at a target surface. The decontamination apparatus 200 may include a control system 220 for controlling the robotic arm 218. The robotic-arm-controlling system may be a computerized system, an automated system, a manual system or any other system capable of controlling a robotic arm.

The robotic arm 218 may include a plurality of interconnected links. The interconnected links may be rotatably coupled with respect to one another. The rotation points of the interconnected links of the robotic arm 218 may be adapted to allow movement in any or all three spatial planes. The robotic arm 218 may be affixedly mounted to any stable surface or any surface of the enclosure about which the plurality of interconnect links may rotate. The interconnected links of the robotic arm 218 may be of varying lengths to facilitate manipulation and movement of items within the enclosure 202.

The decontamination apparatus 200 may include a structure 226 adapted to move the enclosure. The structure 226 for moving the enclosure may include wheels, rollers, gliders, casters, sliders or any other structure known in the art. The structure 226 for moving the enclosure 202 may be adapted to support the weight of the structure when loaded with multiple decontamination systems and multiple articles to be decontaminated. The structure 226 for moving the enclosure 202 may be adapted to allow the enclosure 202 to be moved from one location to another where the different locations may be some distance apart. The structure 226 for moving the enclosure 202 may be adapted to allow the enclosure 202 to be placed on an elevator. The structure 226 for moving the enclosure 202 may be adapted to retract when not in use. The structure 226 for moving the enclosure 202 may be adapted to prevent movement of the enclosure 202 when it is not desired.

The decontamination apparatus 200 may include an observation system 224 adapted to allow observation of the inside of the enclosure 202 from outside the enclosure. The observation system 224 may include a window, a camera, a video port or any other system known in the art. The observation system 224 may be controlled by a system including a computer system, an automated system, a manual system or any other system known in the art.

The decontamination apparatus 200 may include a motility system 214 for moving items within the enclosure during decontamination. The motility system 214 may include a turntable, a vibrator, a robotic arm or any other mechanism known in the art. The motility system 214 may include openings within the enclosure 202 walls to allow for insertion of instruments or human hands. The motility system 214 may include protective gloves attached to openings within the enclosure 202 walls adapted to receive instruments or human hands. The motility system 214 may be adapted to rotate, vibrate, relocate, invert, or otherwise move items located within the enclosure 202 and such items may include articles to be decontaminated, fixtures within the enclosure or any other items to be moved. The motility system 214 may be adapted to elevate, suspend, hang or distribute items within the enclosure 202. The motility system 214 may be of any shape necessary to achieve the desired positioning of any items within the enclosure 202. The motility system 214 may be flat, cylindrical, rectangular, circular, pyramidal, or any other shape known in the art. The motility system 214 may be in the form of a tri-pod, a pedestal, a stand, a hook, a rod, an arm or any other form known in the art. The motility system 214 may be adapted to have a changeable form, as from a cylindrical shape to a flat shape, from a hook form to an arm form, or any other change known in the art. The motility system 214 may be adapted to allow the addition or subtraction of another piece or pieces to change its shape to accommodate items within the enclosure. The motility system 214 may be located on a vertical or horizontal surface of the enclosure 202. The motility system 214 may be located at any position within the interior of the enclosure 202. The motility system 214 may be affixed to the floor portion, the ceiling portion, the wall portion, the lower portion, the middle portion, the upper portion or any other portion of the interior of the enclosure 202.

The decontamination apparatus 200 may include a mechanism for holding items within the enclosure 202. The mechanism for holding items may be a shelf 210, a hook 212 or any other mechanism known in the art. The mechanism (210 or 212) may be adapted to be stowed when not in use and deployed during use.

The decontamination apparatus 200 may include a movement system 208 for moving the gases inside the enclosure. The movement system 208 may include a fan blade, a vacuum apparatus or any other system known in the art. The gases inside the enclosure may include decontamination gases, atmospheric gases or any other gases found within the enclosure 202.

The decontamination apparatus 200 may include a computer system 222 adapted to automate the process of decontamination. The computer system 222 may be adapted to record and store data.

The decontamination apparatus 200 may include a mechanized system for labeling articles. The mechanized system may include a chemically reactive label, a time sensitive label, a computer generated label or any other label known in the art. The mechanized system may include capture, storage and utilization of data within a computerized system 222.

The decontamination apparatus 200 may include an exhaust system 216 adapted to exchange the atmosphere within the enclosure. The atmosphere within the enclosure may include all gases found within the enclosure 202 including decontamination gases used for decontamination.

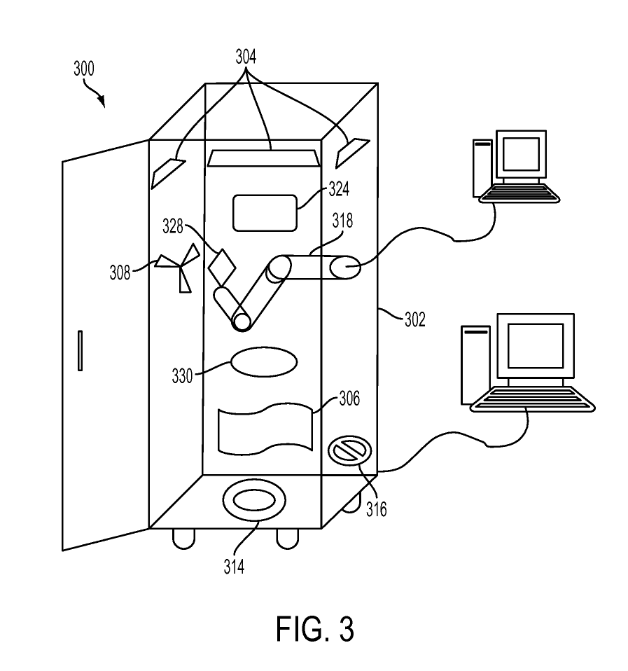

Another exemplary embodiment of a decontamination apparatus is indicated generally as 300 in FIG. 3. The decontamination apparatus 300 may be a self-cleaning unit for the decontamination of small objects (“SUDS”). The SUDS may be a portable decontamination unit with primary (first decontamination system 304), secondary (second decontamination system 306) and tertiary decontamination (third decontamination system 330) systems using aerosolized biocide, ultraviolet light and dry heat respectively. Surface and base rotation via a clockwise and counterclockwise mechanism (motility system 314) may serve to increase the exposure of equipment to the biocide by optimizing air flow directionality. A biocide may be delivered by means of a fogger device 328 affixed to a robotic arm 318. Turbulence generated at the base by a movement system 308 may allow for air flow patterns that increase exposure to the undersurface of the device. Air filtration (via an exhaust system 316) may allow for the expulsion of clean air into the environment, which may be connected to the facility filtration system.

The incorporation of Ultraviolet light may allow for secondary decontamination (the second decontamination system 306). The enclosure may be double layered with a heat element that may allow for temperatures to 300° C. The internal components may be disposable. Dyed paper containing ink devoid of UV light inhibitors, coordinated to coincide with the duration of action of the respective biocide may be applied as tags (chemically reactive labels) onto the hospital equipment (articles to be decontaminated) through an automated tagging mechanism (mechanized system for labeling articles). Color change may occur over the life of the biocide, providing an immediately visible indication that decontamination of an instrument is due.

Image acquisition may be performed by a digital camera (observation system 324) (or alternatively one can use an infrared camera) in 2-dimensions (one can do 3-D images also) to monitor the decontamination progress or inspect the medical equipment remotely. If one uses an infrared camera there may be the added advantage of using thermal imagery to delineate the portions that have not yet been decontaminated. The imaging system may enable the operator to guide the robotic arm 318 and fogger 328 to concentrate on those areas where additional decontamination is required.

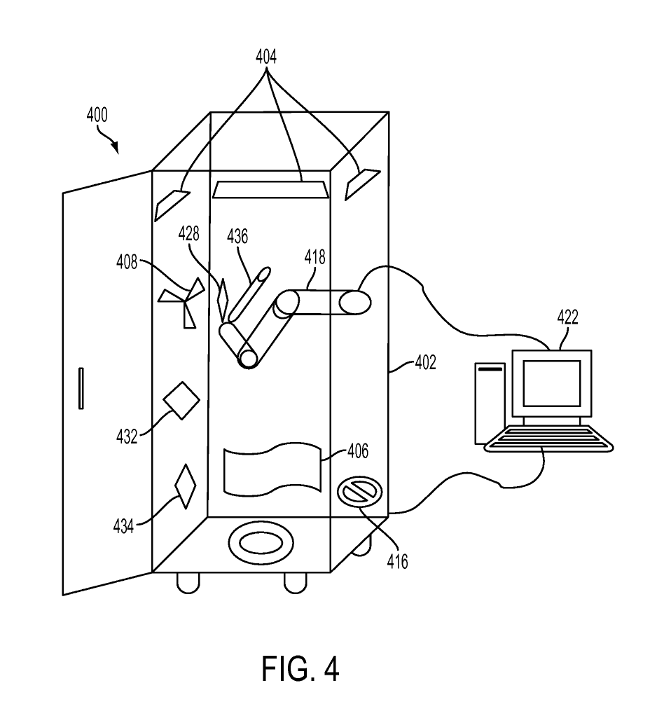

Another exemplary embodiment of a decontamination apparatus is indicated generally as 400 in FIG. 4. The decontamination apparatus 400 may include: a rectangular enclosure 402 with a sealed door for access to the interior; a fogger 428 delivering an aerosolized mist; the fogger 428 may be moved about the interior of the enclosure 402 by a robotic arm 418; a fan 408 for circulating the aerosolized mist throughout the interior; a second sprayer 432 to deliver luminol for detection of blood stains on any of the contents; a third sprayer 434 to deliver ultraviolet deficient ink; the robotic arm 418 may also support an ultraviolet light 436 for self cleaning the interior; one or more cameras for remote inspection of the contents of the enclosure 402; air cleaner 416 for removing the aerosolized mist and delivering clean air out of the unit; and software 422 for operating all the equipment in sequence.

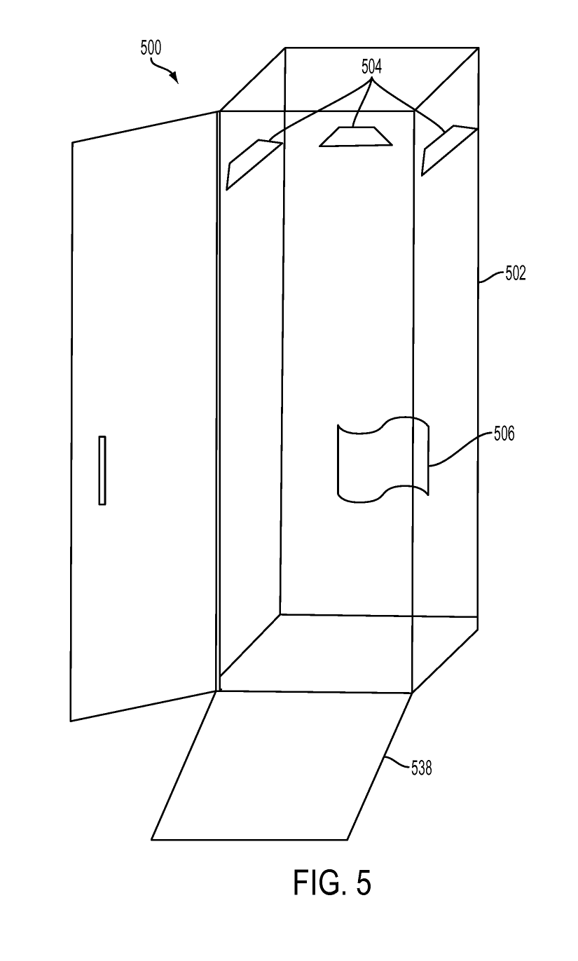

Another exemplary embodiment of a decontamination apparatus, constructed according to the principles of the present disclosure, is indicated generally as 500 in FIG. 5. The decontamination apparatus 500 may include an enclosure 502, a first decontamination system 504, a second decontamination system 506, and an access ramp 528. The ramp 538 may be rectangular, polygonal, or any other shape suitable for access to the interior of the enclosure 502. The ramp 538 may be composed of plastic, steel, polyvinyl chloride, rubber, wood, or any other single material or combination of materials suitable for access to the enclosure 502. The ramp 538 may be adapted to be adjusted as by hinges, risers or any other adjustment means known in the art. The ramp 538 may be affixed to the enclosure 538. The ramp 538 may be adapted to be removably affixed to the enclosure 538. The ramp 538 may be adapted to include a decontamination surface such that any object that comes in contact with that surface such as, for example, wheels or feet moving across the ramp, will be decontaminated. Surface decontamination may be effected by a decontaminating chemical treatment, decontaminating light treatment or any other decontaminating treatment known in the art.

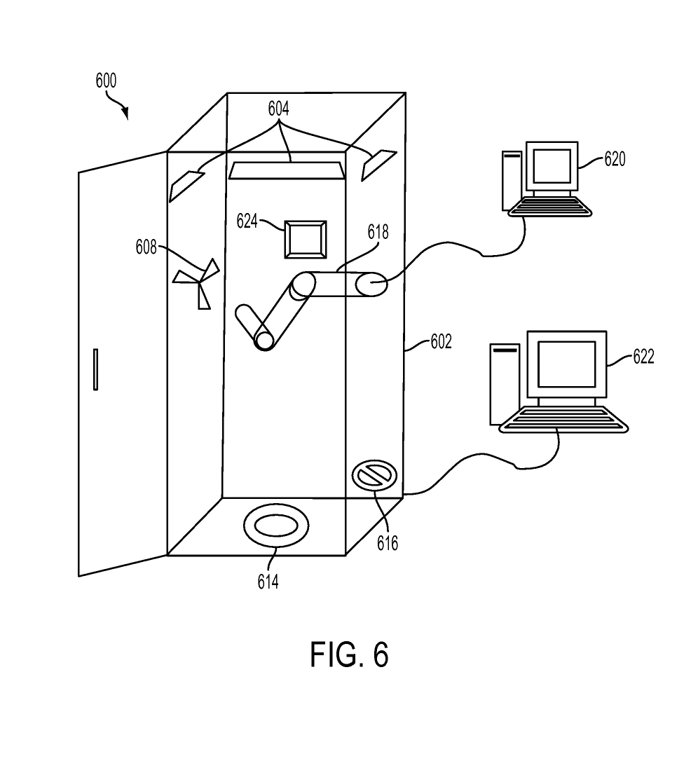

Another exemplary embodiment of a decontamination apparatus, constructed according to the principles of the present disclosure, is indicated generally as 600 in FIG. 6. The decontamination apparatus 600 may include an enclosure 602, a decontamination system 604, a robotic arm 618 adapted to move items within the enclosure 602 and such items may include articles to be decontaminated, fixtures within the enclosure or any other items to be moved. The decontamination apparatus 600 may include an observation system 624, a motility system 614 for moving items within the enclosure during decontamination, an exhaust system 616 adapted to exchange the atmosphere within the enclosure, and a movement system 608 for moving the gases inside the enclosure. The decontamination apparatus 600 may include a control system 620 for controlling the robotic arm 618, and a computer system 622 adapted to automate the process of decontamination.

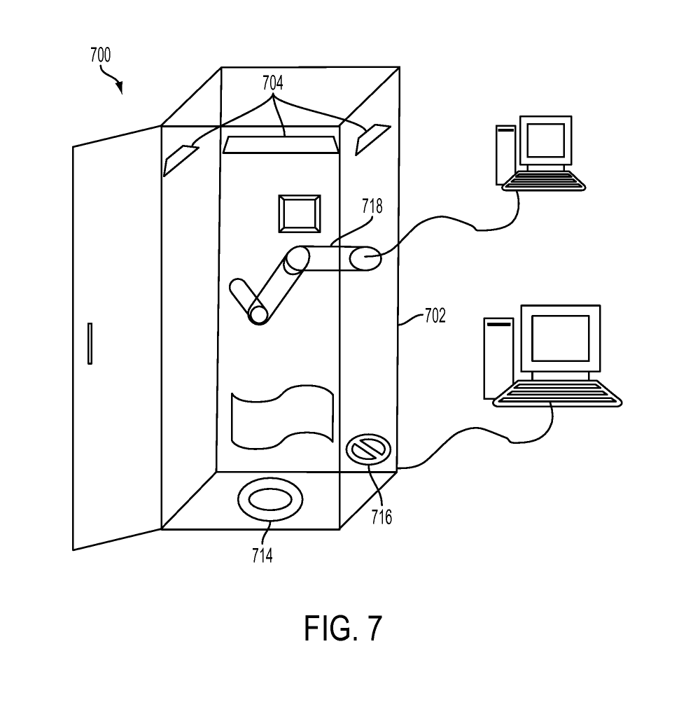

Another exemplary embodiment of a decontamination apparatus, constructed according to the principles of the present disclosure, is indicated generally as 700 in FIG. 7. The decontamination apparatus 700 may include an enclosure 702, a decontamination system 704, a motility system 714, a robotic arm 718, and an exhaust system 716 adapted to exchange the atmosphere within the enclosure.

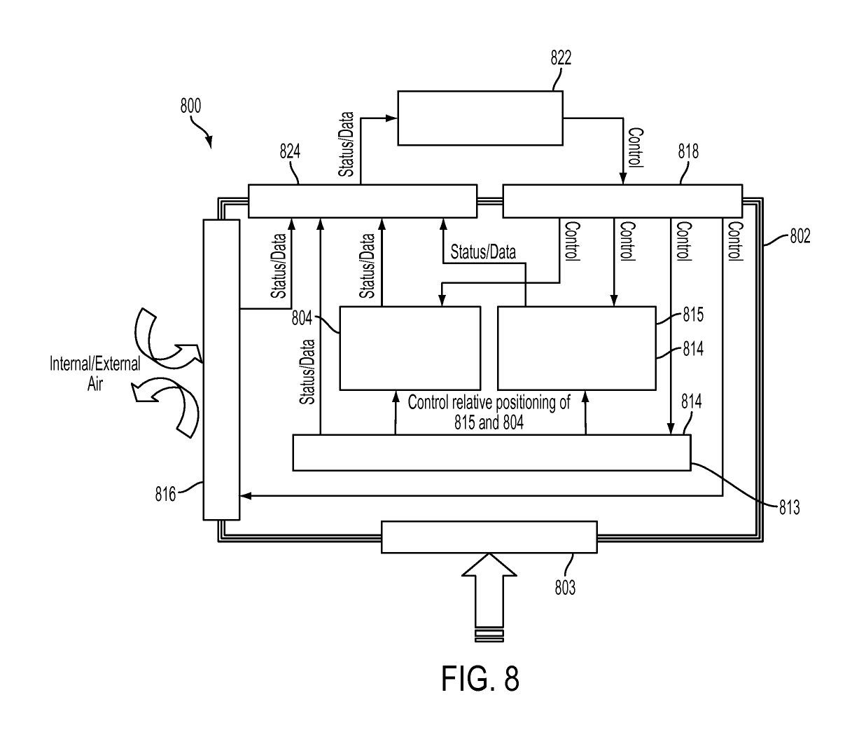

Another exemplary embodiment of a decontamination apparatus, constructed according to the principles of the present disclosure, is indicated generally as 800 in FIG. 8. The decontamination apparatus 800 may include an enclosure 802 containing a door 803, a decontamination system 804, a motility system 814 comprising a moving surface 813 and a support structure 815, a robotic arm 818, an exhaust system 816, an observation system 824, and a computerized system 822 adapted to capture, store and utilize of data within the decontamination apparatus 800 and control its operation. The arrows in FIG. 8 indicate possible flow routes of data, and relationships between components.

In one example, a decontamination apparatus, constructed according to the principles of the present disclosure was evaluated in an emergency department setting in a hospital. Surfaces of portable medical equipment were tested both before and after use. Object surfaces were re-cultured 48 hours after decontamination using the apparatus and again following re-introduction of the objects into the clinical setting. After manual decontamination, 25% (23/91) of the tested objects in the emergency department were found to be culture positive with clinically significant microorganisms. Fifteen percent of non-critical equipment tested had multiple organisms. Following the use of the decontamination apparatus, the colonization rate decreased to 0%; following re-introduction of these objects into the clinical settings, and again after 48 hours the contamination rates remained 0%. This would lead to the conclusion that the decontamination apparatus provides effective and durable decontamination of hospital equipment of varying sizes in the clinical area without disrupting patient care.

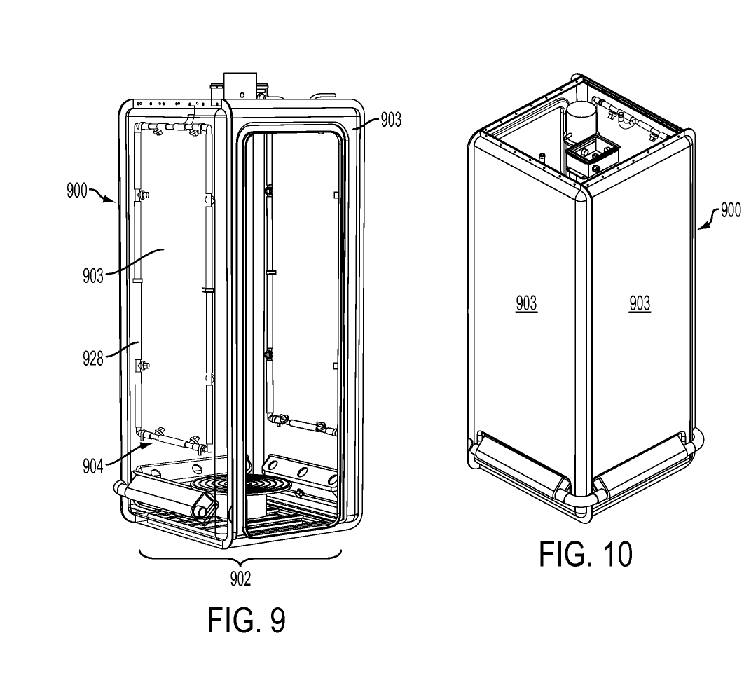

FIG. 9 depicts a front perspective view of a prefabricated modular decontamination apparatus 900 according to an embodiment of the invention. FIG. 10 is a rear perspective view of the modular decontamination apparatus 900 according to the embodiment shown in FIG. 9. The decontamination apparatus 900 shown in the embodiment depicted in FIGS. 9 and 10 may include a plurality of prefabricated modular walls (panels) 903 arranged and coupled to one another to define an enclosure 902. The modular decontamination apparatus 900 depicted in FIG. 9 defines a single unit configuration. As will be further described below, the modular and standardized design of the walls 903 allows the apparatus 900 to be constructed in multiple unit configurations such as, for example but not limited to, two unit configurations, three unit configurations, four unit configurations, five unit configurations, six unit configurations, etc. This may provide flexibility based on needs and possible uses of the apparatus. In particular, the ability to reconfigure multiple single-unit apparatuses into a single multi-unit apparatus allows larger items and/or larger number of items to be contaminated in a centralized manner, while retaining the ability to reconfigure the apparatus into multiple single-unit apparatuses for smaller scale decontamination at distributed sites as needs might require.

The modular decontamination apparatus 900 may be, for example but not limited to, a portable self-cleaning unit for the decontamination of small objects (“SUDS”). The decontamination apparatus 900 may include one or more decontamination systems 904. The decontamination system 904 may include, for example, a washing, spraying and/or misting disinfectant supply device 928 adapted to deliver a chemical disinfectant by distributing the chemical throughout the enclosure and for high pressure cleaning of the chamber and any equipment therein. The disinfectant supply device 928 may deliver the chemical in the form of a gas, liquid, suspension, solution, aerosol, or any other form known in the art. The disinfectant supply device 928 is shown in FIG. 9 as being a plurality of connected tubular members and spraying nozzles removably affixed to the interior of the enclosure 902 by brackets and fasteners, but could also be affixed to, unattached to, slidably affixed to, or connected to the interior of the enclosure 902 by any other means known in the art suitable for positioning the disinfectant supply device 928 within the enclosure.

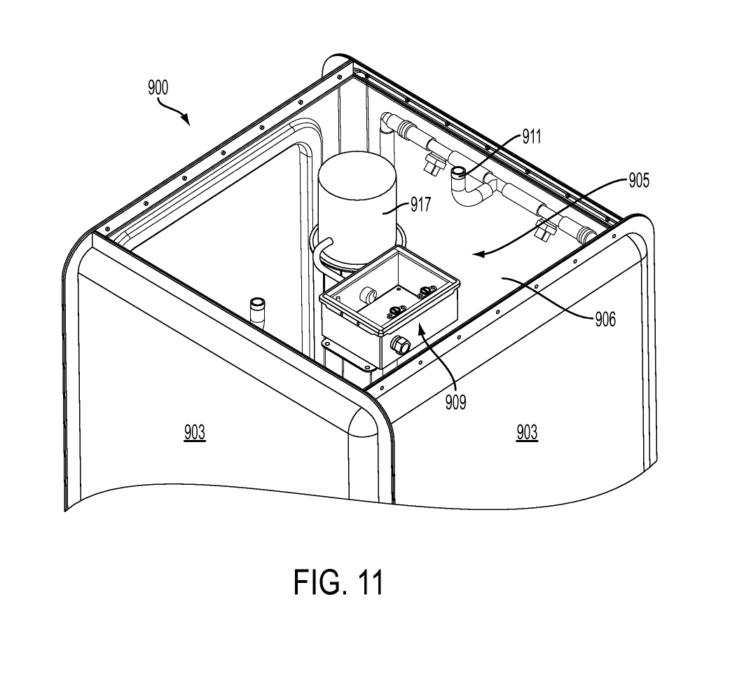

FIG. 11 is a detailed perspective view of a top of the modular decontamination apparatus 900 according to the embodiment shown in FIGS. 9 and 10. A ceiling panel assembly 905 is shown including a prefabricated modular ceiling panel 906 coupled to a top portion of each of the prefabricated modular walls (panels) 903, an electrical junction box module 909 configured to supply power to powered elements of the modular decontamination apparatus 900, and at least one external source supply tube 911 configured to couple the disinfectant supply device 928 within the enclosure 902 to an externally located disinfectant supply source (not shown). The supply tube could also be arranged to enter through any of the other prefabricated modular walls (panels) 903.

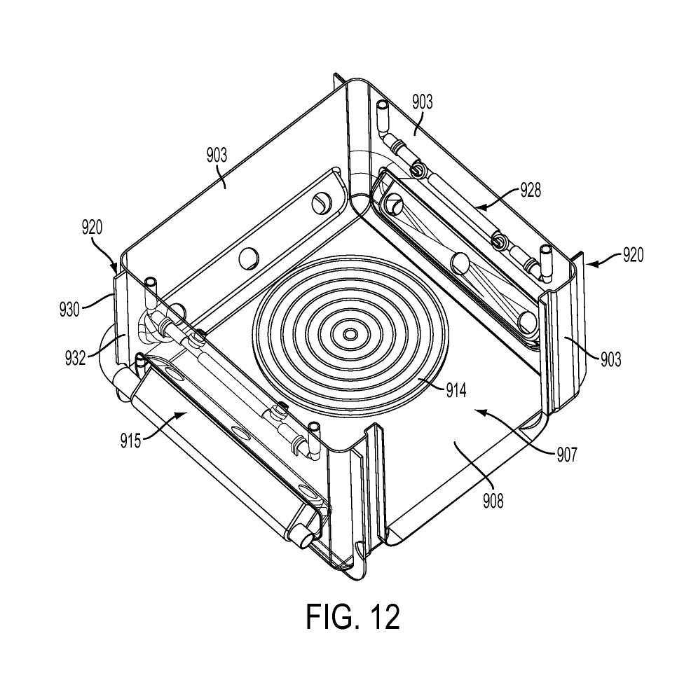

FIG. 12 is a partial perspective view of an interior bottom portion of the modular decontamination apparatus 900 according to the embodiment shown in FIG. 9. A floor panel assembly 907 is shown including a prefabricated modular floor panel 908 coupled to a bottom portion of each of the prefabricated modular walls (panels) 903. The floor panel assembly 907 may also include a motility system 914 for moving items within the enclosure 902 during decontamination. The motility system 914 shown in the embodiment depicted in FIG. 9 includes a powered rotating mechanism such as, for example, a turntable adapted to rotate (clockwise or counterclockwise) items located within the enclosure 902. The motility system 914 could, alternatively or additionally, include other elements such as, for example, a vibration element, a robotic arm or any other movement mechanism known in the art to vibrate, relocate, invert, elevate, suspend, hang, distribute, or otherwise move items located within the enclosure 902. Such items may include, for example, articles to be decontaminated, fixtures within the enclosure or any other items to be moved. The motility system 914 may be of any shape necessary to achieve the desired positioning of any items within the enclosure 902. The motility system 914 may be flat, cylindrical, rectangular, circular, pyramidal, or any other shape known in the art. The motility system 914 may be adapted to allow the addition or subtraction of another piece or pieces to change its shape to accommodate items within the enclosure. The motility system 914 may be located on a vertical or horizontal surface of the enclosure 902. The motility system 914 may be located at any suitable position within the interior of the enclosure 902. While shown affixed to the floor panel 908 of the enclosure 902 in the embodiment depicted in FIG. 9, the motility system 914 may be affixed to the ceiling portion 906, the lower, middle, or upper portion of one or more of the walls 903, or any other portion of the interior of the enclosure 902.

As shown in the embodiment depicted in FIGS. 9, 10, and 12, one or more of the walls 903 of the decontamination apparatus 900 may also include one or more air ducts 915 coupled to or integrally formed therein. The air duct 915 may be, for example, disposed near a lower portion of the wall 903, proximate to the floor panel assembly 907 when the enclosure 902 is constructed and/or near an upper portion proximate the ceiling panel 906. The air ducts 915 may be regulated for circulation and/or drying. When assembled, each of the walls 903 of the decontamination apparatus 900 may be coupled to adjacent walls at a flanged joint 920, for example, by fasteners including, but not limited to, bolts, screws, rivets, snap fit, friction fit, adhesive, or a combination thereof.

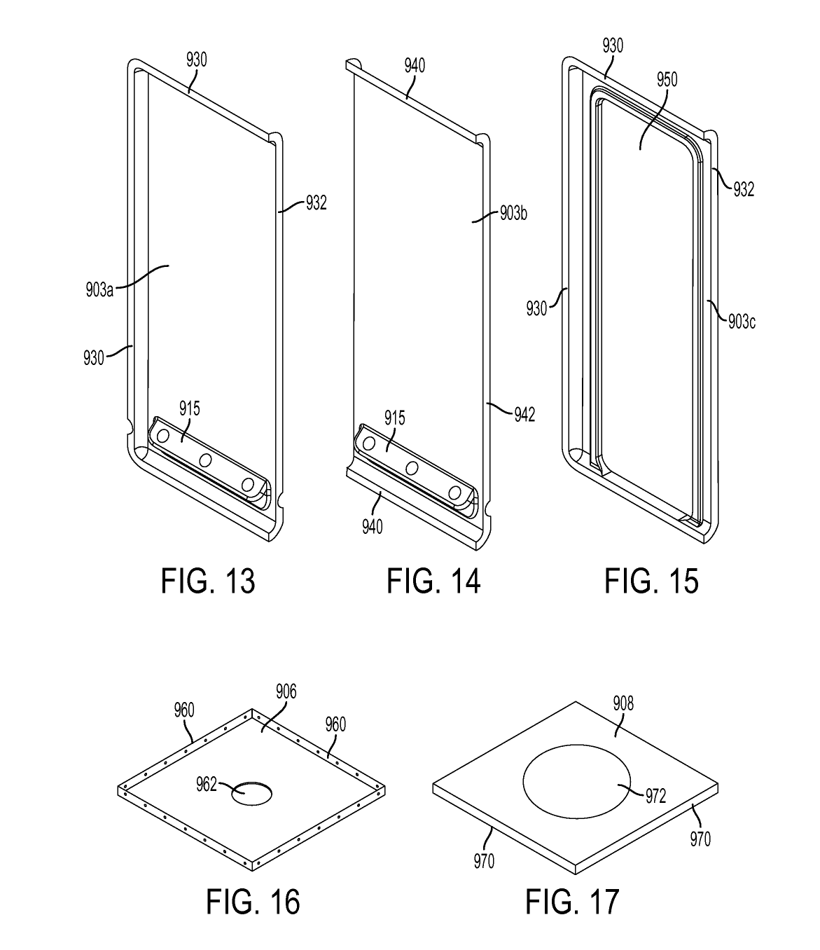

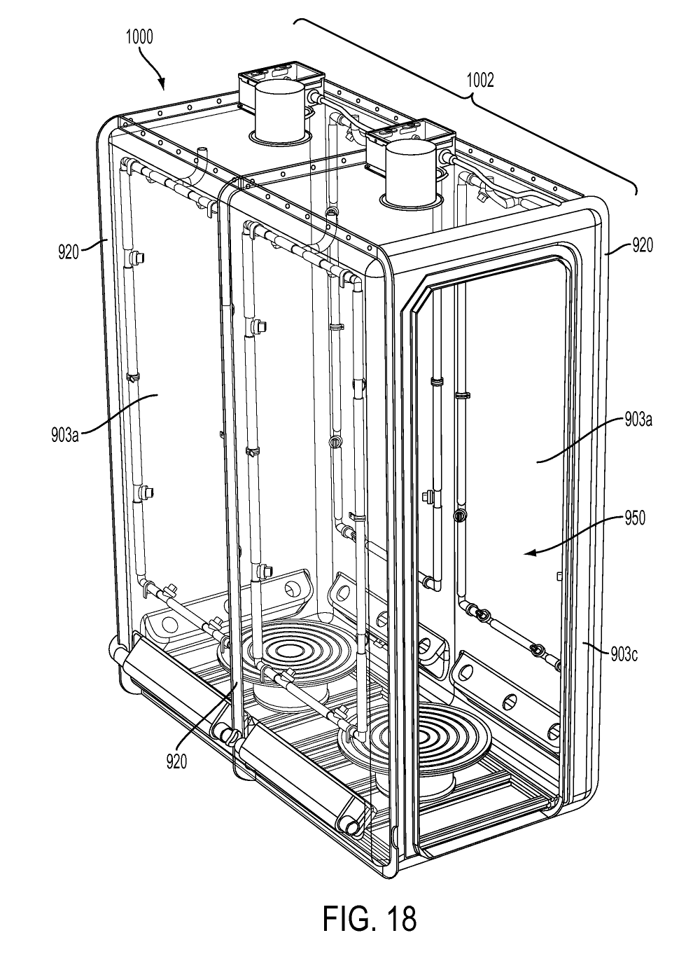

FIGS. 13-15 are perspective views of three types of prefabricated modular side walls or panels 903 available as needed for constructing a single unit modular decontamination apparatus 900, such as in the embodiment shown in FIG. 9, or a multi-unit decontamination apparatus 1000, 1100, 1200, such as in the embodiments shown in FIGS. 18-23 (discussed further below). The prefabricated modular side walls or panels 903 and the ceiling and floor panels 906, 908, may be formed from any suitable material such as, for example but not limited to, fiberglass reinforced plastic (FRP), sheet metal, plastic, or a combination thereof. FIG. 13 shows a side wall 903a which may include an integrated air duct 915. Disposed around at least a portion of the periphery or outer edge of the side wall 903a is a first flange 930. The first flange 930 may be, for example, along three edges of the side wall 903a and may be substantially parallel to the main body of the side wall 903a. A second flange 932 may be provided along one of the outer edges of the side wall 903a, the second flange 932 being oriented at an angle such as, for example, 90 degrees, relative to the first flange 930. As shown in FIG. 12, two adjacent side walls 903 (in the form of side wall 903a) may be coupled at flanged joint 920 by joining and securing together the first flange 930 of one side wall 903 and the second flange 932 of the other side wall 903. The ceiling and floor panels 906, 908 may also be coupled to the first flange 930 of side wall 903a at similar flanged joints. FIG. 15 shows a side wall 903c which may be substantially similar to side wall 903a except that it may not have an air duct 915 and may include an access opening 950 which may be opened/closed by a hinged door (not shown). Like side wall 903a, disposed around the periphery or outer edges of the side wall 903c are first and second flanges 930, 932. The first flange 930 may be, for example, along three edges of the side wall 903c and may be substantially parallel to the main body of the side wall 903c. The second flange 932 may be provided along one of the outer edges of the side wall 903c, the second flange 932 being oriented at an angle such as, for example, 90 degrees, relative to the first flange 930. As shown in FIG. 12, adjacent side walls 903a and 903c may be coupled at flanged joint 920 by joining and bolting together the first flange 930 of side wall 903c and the second flange 932 of side wall 903a. The ceiling and floor panels 906, 908 may also be coupled to the first flange 930 of side wall 903c at similar flanged joints.

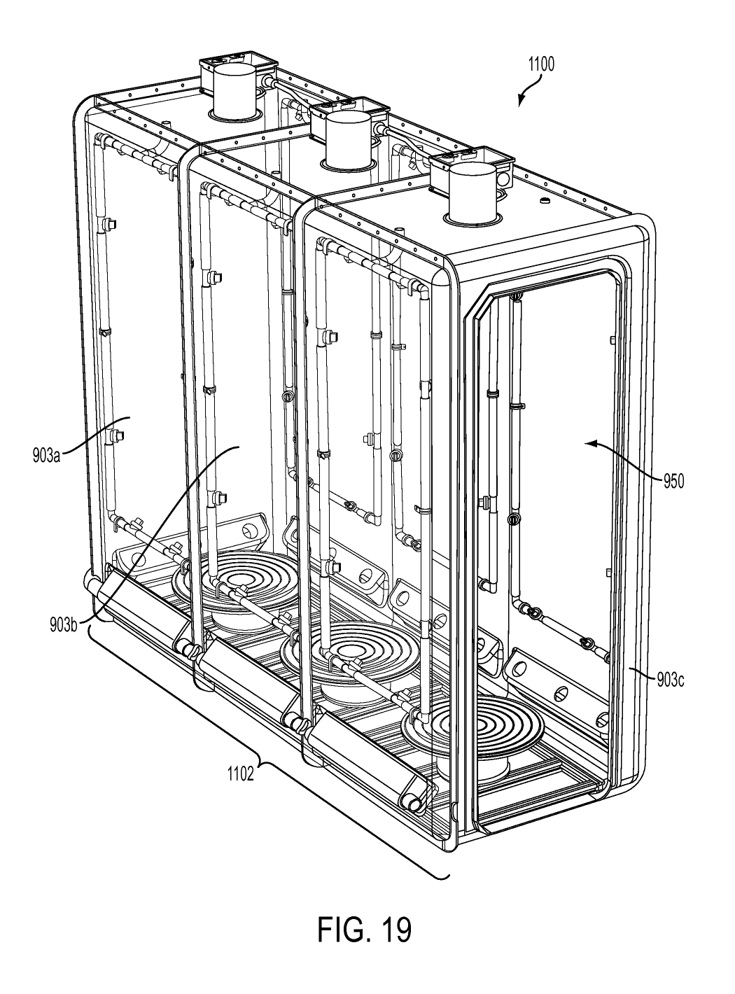

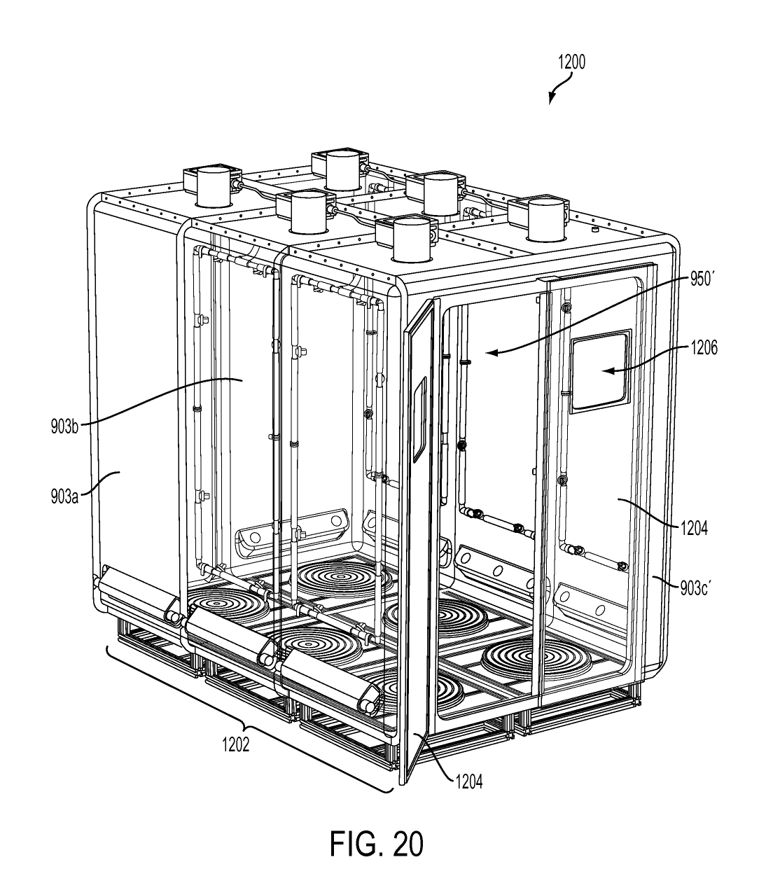

FIG. 14 shows a side wall 903b which may include an integrated air duct 915. Disposed around at least a portion of the periphery, in particular the upper and lower outer edges of the side wall 903b is a first flange 940. The first flange 940 may be substantially parallel to the main body of the side wall 903b. A second flange 942 may be provided along the outer side edges of the side wall 903b, the second flange 942 being oriented at an angle such as, for example, 90 degrees, relative to the first flange 940. As shown in FIGS. 19 and 20, for example, side wall 903b may be positioned as a center wall between two adjacent side walls 903a may be coupled at flanged joint 920 by joining and bolting together the first flange 930 of one side wall 903 and the second flange 932 of the other side wall 903.

FIG. 16 shows the ceiling panel 906 including flanges 960 for coupling to the top edge and first flange 930, 940 of any of the side walls 903a, b, c. Ceiling panel 906 may also include a centrally located hole 962 for receiving a light fixture 917 (see FIGS. 9-11) such as, for example, a UV or LED light source, arranged and configured to illuminate the interior of the enclosure 902. FIG. 17 shows the floor panel 908 including flanges 9700 for coupling to the bottom edge and first flange 930, 940 of any of the side walls 903a, b, c. Floor panel 908 may also include a centrally located hole 972 for receiving the motility system 914 arranged and configured to move items or articles within the enclosure 902 during decontamination.

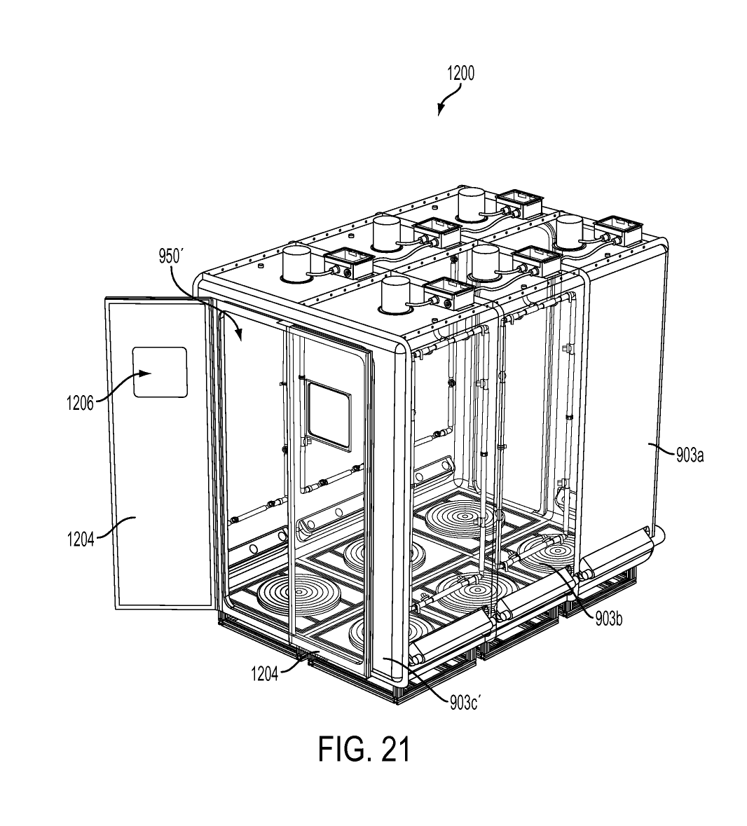

FIG. 18 is a front perspective view of a two unit modular decontamination apparatus 1000 according to another exemplary disclosed embodiment. The two-unit apparatus may be constructed, for example, by reconfiguring the parts of two one-unit apparatuses. The decontamination apparatus 1000 may include a plurality of prefabricated modular side walls (panels) 903a and at least one side wall 903c with access opening 950 arranged and coupled to one another to define an enclosure 1002. FIG. 19 is a front perspective view of a three unit modular decontamination apparatus 1100 according to another exemplary disclosed embodiment. The three-unit apparatus may be constructed, for example, by reconfiguring the parts of three one-unit apparatuses. The decontamination apparatus 1100 may include a plurality of prefabricated modular side walls (panels) 903a,b and at least one side wall 903c with access opening 950 arranged and coupled to one another to define an enclosure 1102. FIGS. 20-21 are front perspective views of a six unit modular decontamination apparatus 1200 according to another exemplary disclosed embodiment. The six-unit apparatus may be constructed, for example, by reconfiguring the parts of six one-unit apparatuses. The decontamination apparatus 1200 may include a plurality of prefabricated modular side walls (panels) 903a,b and at least one side wall 903c′ with an access opening 950′ arranged and coupled to one another to define an enclosure 1202. The access opening 950′ may be opened/closed by one or more doors 1204, for example two doors, hingedly coupled to the panel 903c′. The decontamination apparatus 1200 (as well as any of the other described embodiments of the decontamination apparatus) may include an observation system 1206 arranged to allow observation of the inside of the enclosure 1202 from outside the enclosure 1202. The observation system 1206 may include, for example, but not limited to a window, a camera, a video port or any other system known in the art. The observation system 1206 may be controlled by a system including a computer system, an automated system, a manual system or any other system known in the art.

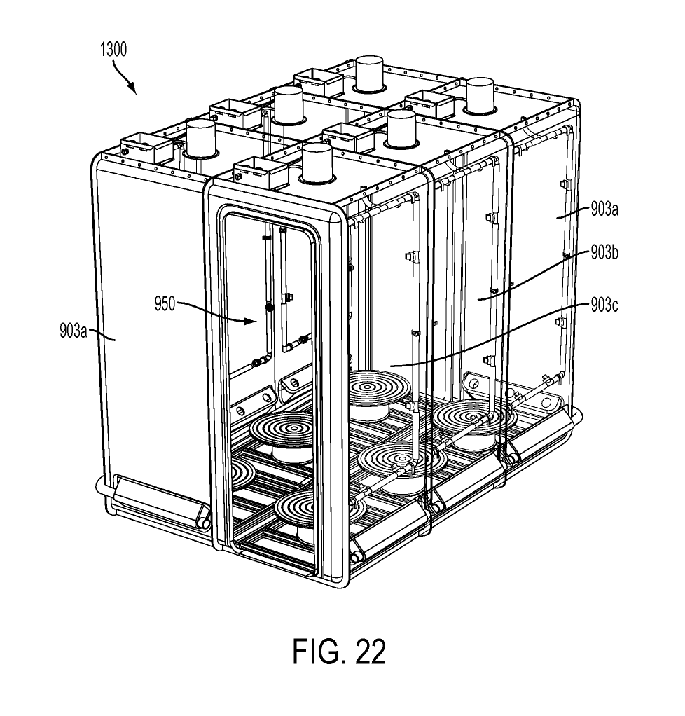

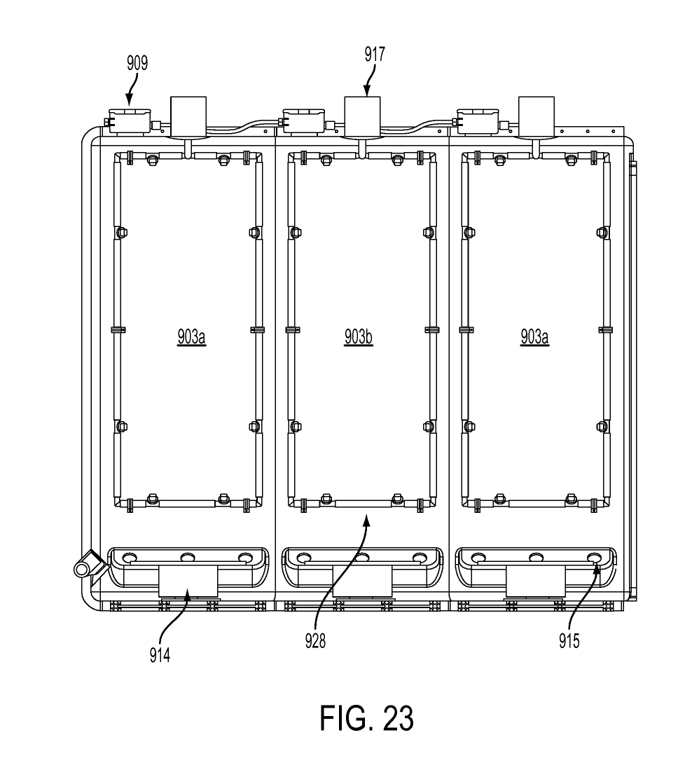

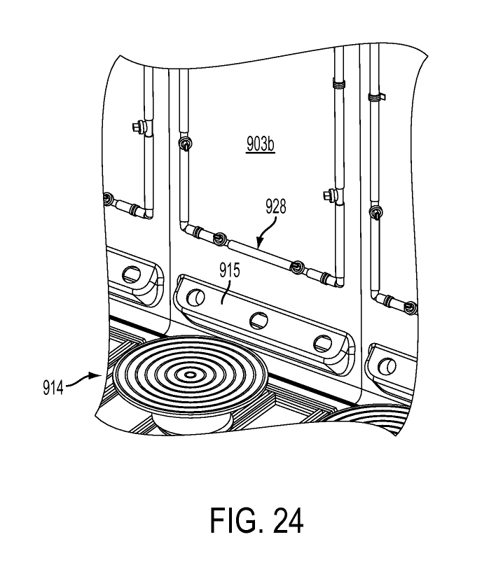

FIG. 22 is a rear perspective view of a six unit modular decontamination apparatus 1300 according to another embodiment. The apparatus 1300 may be substantially the same as the six unit apparatus 1200 shown in FIGS. 21-22, except that, instead of double doors, the access opening 950 may only require a single door (not shown). Additionally, the apparatus 1300 may have a single door at opposite ends of the enclosure 1302. FIG. 23 is a side view of the six unit modular decontamination apparatus 1300 according to the embodiment shown in FIG. 22. The apparatus 1300 may have two side walls 903a and one center side wall 903b along one side of the enclosure 1302. Also shown in FIG. 23 are the electrical junction boxes 909, light fixtures 917, motility devices 914, disinfectant supply device 928, and air ducts 915. FIG. 24 is a partial perspective view of an interior bottom portion of the modular decontamination apparatus 1300 according to the embodiment shown in FIG. 23 including side wall 903b, motility device 914, disinfectant supply device 928, and air ducts 915.

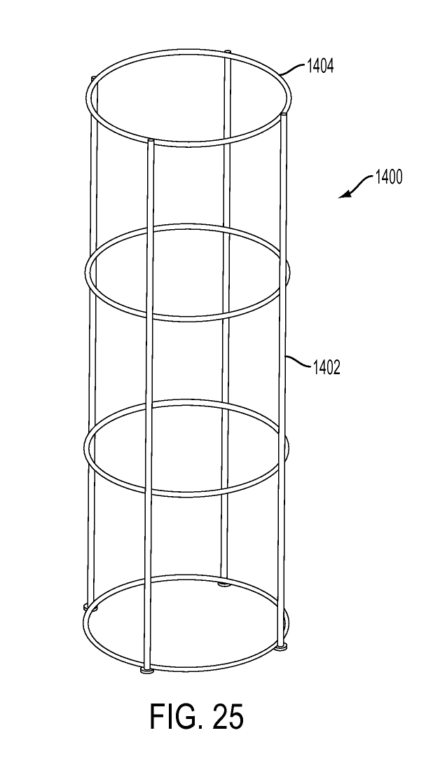

FIG. 25 is a front perspective view of an equipment hanger rack 1400 for use with any of the described modular decontamination apparatuses according to another exemplary disclosed embodiment. The equipment hanger rack 1400 may include, for example, a plurality of longitudinally extending rods 1402 spaced from one another and coupled to a plurality of support members 1404. The longitudinally extending rods 1402 may be vertically oriented and substantially parallel to one another and the support members may include horizontally oriented rings. The equipment hanger rack 1400 may be formed from any suitable material such as for example, metal, plastic, or a combination thereof. There may be four rods 1402 or another other number of rods such as one, two, three, five, etc. so long as the number of rods is sufficient to provide vertical support to the support members and maintain the rack 1400 upright. The rods 1402 may or may not be parallel to one another. The support members 1404 are shown in FIG. 25 as circular but may be of any suitable shape such as, for example, rectangular, square, triangular, etc. the support members 1404 may be substantially parallel to one another or they may be at an angle relative to each other.

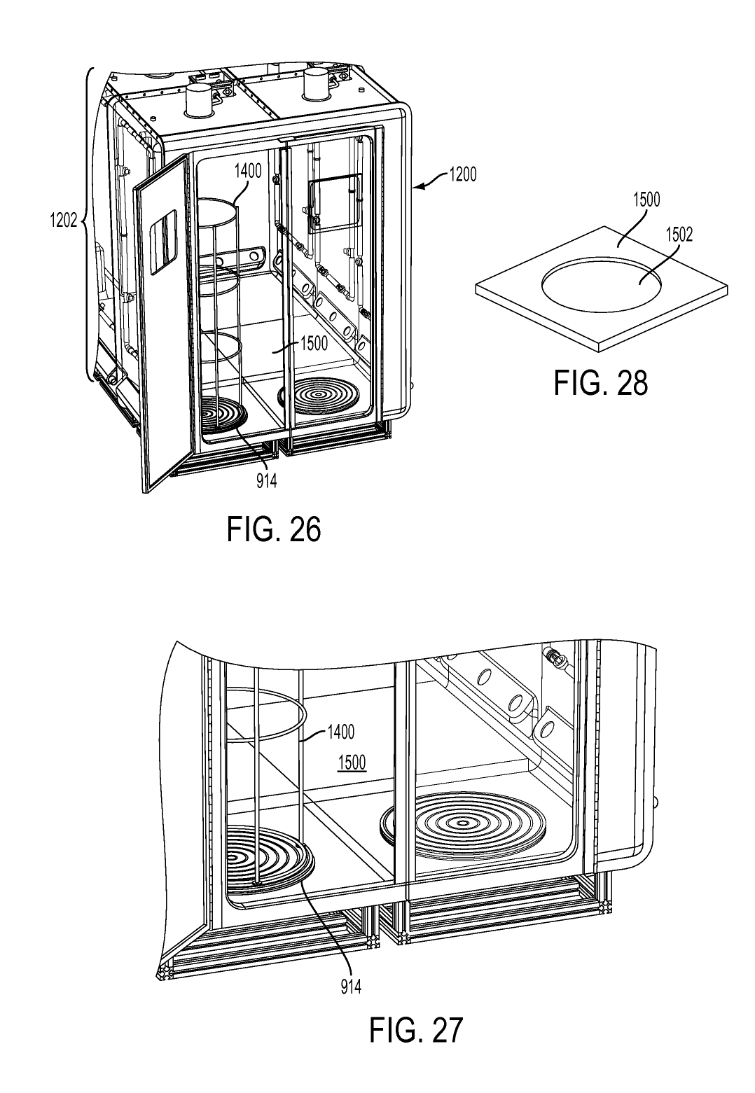

FIG. 26 is a front perspective view of the equipment hanger rack 1400 of FIG. 25 positioned within a modular decontamination apparatus 1200 according to another exemplary disclosed embodiment. The rack 1400 is shown positioned on a respective one of the motility devices 914. Other motility devices 914 in the enclosure 1202 may be covered by suitably constructed cover members 1500 to provide a solid, non-moving floor when movement of independent motility devices 914 is not necessary such as when a solid floor is needed for a large article or piece of equipment is received in the enclosure 1202 for disinfecting. FIG. 27 is a front detailed perspective view of the equipment hanger rack 1400 positioned on a motility device 914 within the modular decontamination apparatus 1200 as shown in FIG. 26. FIG. 28 is a front perspective view of a removable turntable cover member 1500. The cover 1500 may include a central circular recess for receiving a top surface of the motility device 914 when such device 914 is a circular turntable.

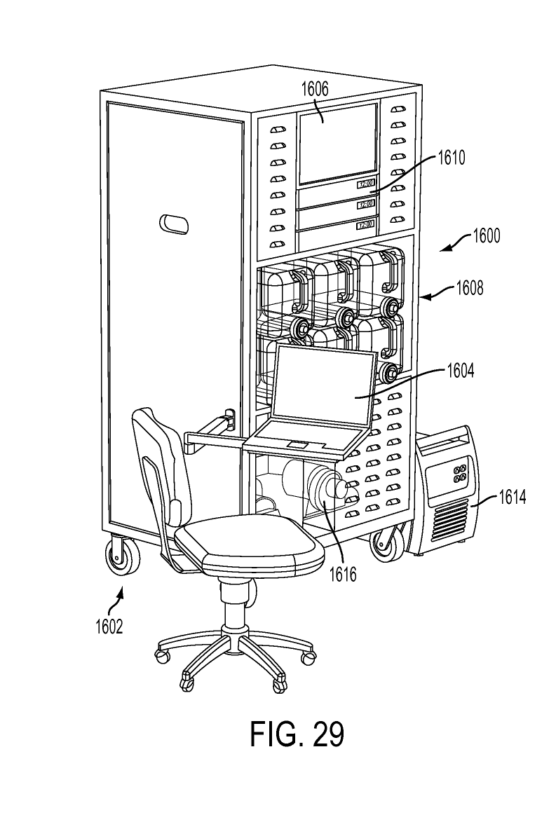

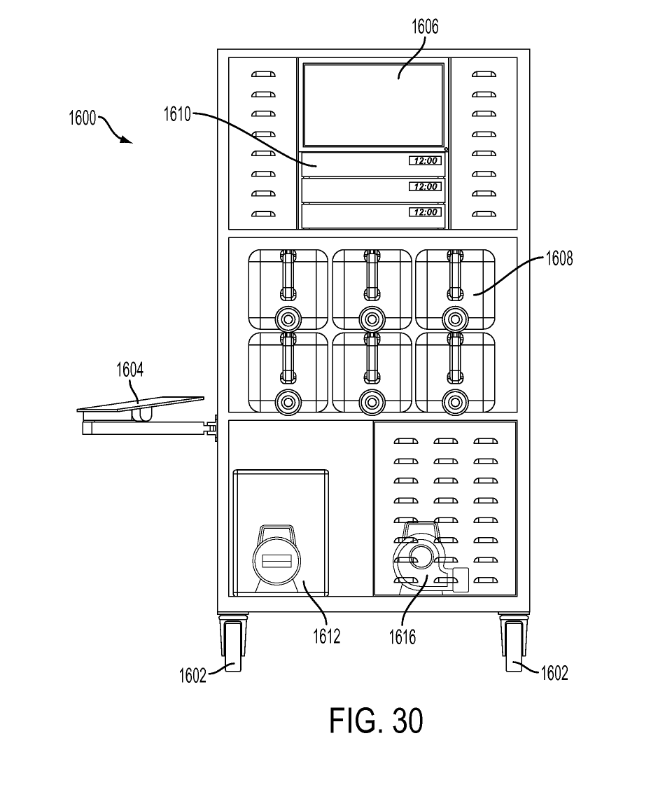

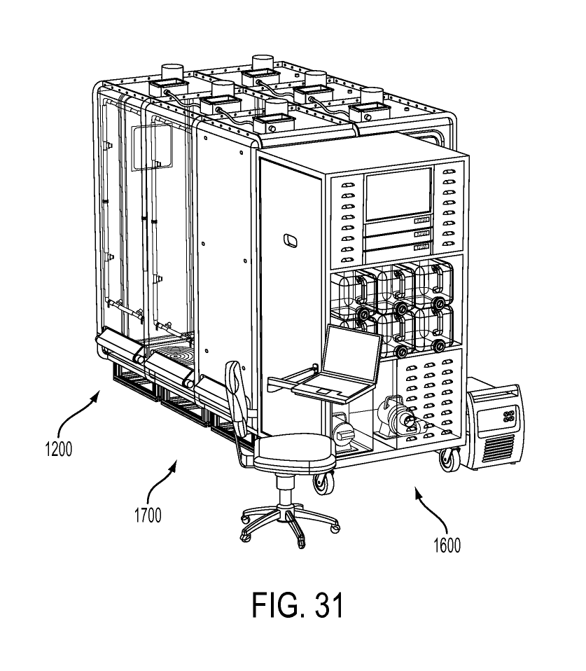

FIG. 29 is a front perspective view of a mobile or portable control and supply module 1600 according to another exemplary disclosed embodiment for use with any of the previously described modular decontamination apparatuses. FIG. 30 is a front view of the portable control module 1600. The control and supply module 1600 may include a movement device 1602 such as, for example, wheels, rollers, gliders, casters or sliders, to provide mobility. The control and supply module 1600 may further include a computer system 1604 for data input, recordation and storage and may be adapted to automate the process of decontamination. The computer system 1604 can be used to set or change a cleaning cycle and allows programmable functionality for multiple cycles and/or systems. An instrumentation display panel 1606 such as, for example, an LED panel, may be provided for continuous monitoring of the systems. Disinfectant supply tanks 1608 may be provided which can be filled with one or more cleaning agents based on application requirements. A system timer and temperature control unit(s) 1610 may be provided on the module 1600. The module 1600 may also include a fluid regulator 1612, a power distribution unit 1614 (e.g., portable or direct current), an air compressor and regulator 1616, an air particle filtration system (not shown), and a chamber disinfectant verification system (not shown). FIG. 31 is a front perspective view of a modular decontamination system 1700 including the modular decontamination apparatus 1200 and the portable control and supply module 1600 according to an embodiment.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

We claim:

1. A decontamination apparatus, comprising:
an enclosure adapted to contain articles to be decontaminated;
a first decontamination system disposed within the enclosure; and
a second decontamination system disposed within the enclosure,
wherein the second decontamination system relies on a different type of decontamination than the first decontamination system.

2. The apparatus according to claim 1, wherein the first decontamination system comprises a chemical decontamination system.

3. The apparatus according to claim 2, wherein the first decontamination system further comprises a fogger adapted to deliver a chemical by distributing a fog of the chemical throughout the enclosure.

4. The apparatus according to claim 2, wherein the chemical decontamination system further comprises a chemical capable of decontamination, wherein the chemical is selected from a group comprising water, Sporicidin®, Oxivir Tb, SafeSpace®, and B Sanitized.

5. The apparatus according to claim 1, wherein the first decontamination system comprises a UV light capable of decontamination within the enclosure.

6. The apparatus according to claim 1, further comprising a robotic arm adapted to direct a decontamination system at a target surface.

7. The apparatus according to claim 6, further comprising a system for electronically controlling the robotic arm.

8. The apparatus according to claim 1, wherein the apparatus further comprises a structure adapted to move the enclosure.

9. The apparatus according to claim 8, wherein the structure includes a device selected from a group comprising wheels, rollers, gliders, casters and sliders.

10. The apparatus according to claim 1, further comprising an observation system for observing the inside of the enclosure from the outside of the enclosure.

11. The apparatus according to claim 10, wherein the observation system comprises a window adapted to allow viewing through a surface of the enclosure.

12. The apparatus according to claim 10, wherein the observation system comprises a camera.

13. The apparatus according to claim 1, further comprising a motility system for moving items within the enclosure during decontamination.

14. The apparatus according to claim 13, wherein the motility system is adapted to rotate the items.

15. The apparatus according to claim 13, wherein the motility system comprises a robotic arm.

16. The apparatus according to claim 1, further comprising a surface within the enclosure, wherein the surface can be deployed during use and stowed when not in use.

17. The apparatus according to claim 1, further comprising a movement system for moving the gases inside the enclosure.

18. The apparatus according to claim 17, wherein the movement system comprises a fan blade.

19. The apparatus according to claim 1, further comprising a computer system for automating the process of decontamination.

20. The apparatus according to claim 19, wherein the computer system is adapted to record and store data.

21. The apparatus according to claim 1, further comprising a mechanized system for labeling the articles.

22. The apparatus according to claim 21, wherein the mechanized system comprises a chemically reactive label.

23. The apparatus according to claim 1, further comprising an exhaust system adapted to exchange the atmosphere within the enclosure.

24. The apparatus according to claim 1, wherein the enclosure is defined by a plurality of prefabricated modular walls.

25. The modular decontamination apparatus according to claim 24, wherein each prefabricated modular wall includes a flange configured to be coupled to the flange of an adjacent prefabricated modular wall at a flange joint.

26. The modular decontamination apparatus according to claim 25, wherein the flanges of adjacent prefabricated modular walls are coupled together at the flange joint by fasteners.

27. The modular decontamination apparatus according to claim 26, wherein the fasteners include one or more of bolts, screws, rivets, snap fit, friction fit, adhesive, or a combination thereof.

28. The modular decontamination apparatus according to claim 24, wherein a first prefabricated modular wall includes:
a first flange disposed along at least three peripheral outer edges of the wall; and
a second flange disposed along the other peripheral outer edge of the wall and oriented at an angle relative to the first flange.

29. The modular decontamination apparatus according to claim 28, wherein the angle comprises 90 degrees.

30. The modular decontamination apparatus according to claim 28, wherein a second prefabricated modular wall includes:
a first flange disposed along two peripheral outer edges of the wall; and
a second flange disposed along the other two peripheral outer edges of the wall and oriented at an angle relative to the first flange.

31. The modular decontamination apparatus according to claim 28, wherein the prefabricated modular wall includes:
an access opening configured to allow entry and egress of items into and out of the enclosure, wherein the access opening may include a door.

32. The modular decontamination apparatus according to claim 24, wherein each of the prefabricated modular walls is formed from fiberglass reinforced plastic.

33. The modular decontamination apparatus according to claim 24, further comprising modular floor and ceiling panels configured to be coupled to top and bottom portions of the prefabricated modular side walls, respectively.

34. A decontamination apparatus, comprising:
an enclosure adapted to contain articles to be decontaminated;
a decontamination system disposed within the enclosure; and
a motility system for moving items within the enclosure during decontamination.

35. The apparatus according to claim 34, wherein the motility system comprises a robotic arm.

36. A modular decontamination apparatus, comprising:
an enclosure adapted to contain articles to be decontaminated, wherein the enclosure is defined by a plurality of prefabricated modular walls; and
a first decontamination system arranged within the enclosure and configured to decontaminate the articles received in the enclosure.

37. The modular decontamination apparatus according to claim 36, wherein each prefabricated modular wall includes a flange configured to be coupled to the flange of an adjacent prefabricated modular wall at a flange joint.

38. The modular decontamination apparatus according to claim 37, wherein the flanges of adjacent prefabricated modular walls are coupled together at the flange joint by fasteners.

39. The modular decontamination apparatus according to claim 36, wherein a first prefabricated modular wall includes:
a first flange disposed along at least three peripheral outer edges of the wall; and
a second flange disposed along the other peripheral outer edge of the wall and oriented at an angle relative to the first flange.

40. The modular decontamination apparatus according to claim 39, wherein the angle comprises 90 degrees.

41. The modular decontamination apparatus according to claim 39, wherein a second prefabricated modular wall includes:
a first flange disposed along two peripheral outer edges of the wall; and
a second flange disposed along the other two peripheral outer edges of the wall and oriented at an angle relative to the first flange.

42. The modular decontamination apparatus according to claim 39, wherein the prefabricated modular wall includes:
an access opening configured to allow entry and egress of items into and out of the enclosure, wherein the access opening may include a door.

43. The modular decontamination apparatus according to claim 36, wherein each of the prefabricated modular walls is formed from fiberglass reinforced plastic.

44. The modular decontamination apparatus according to claim 36, further comprising modular floor and ceiling panels configured to be coupled to top and bottom portions of the prefabricated modular side walls, respectively.

45. The modular decontamination apparatus according to claim 36, further comprising a mobile control and supply module.

46. The modular decontamination apparatus according to claim 45, wherein the mobile control and supply module includes a movement device configured to allow movement of the module selected from a group comprising wheels, rollers, gliders, casters and sliders.

47. The modular decontamination apparatus according to claim 45, wherein the mobile control and supply module includes a computer system for data input, recordation and storage and configured to automate the process of decontamination.

48. The modular decontamination apparatus according to claim 47, wherein the mobile control and supply module includes an instrumentation display panel, a disinfectant supply tank, a system timer, a fluid regulator, a power distribution unit, and an air compressor and regulator.

49. The modular decontamination apparatus according to claim 36, wherein the prefabricated modular walls permit reconfiguration of multiple single-unit apparatuses into a larger multi-unit apparatus to handle larger articles and/or a larger number of articles.
